(19) United States
(12) Patent Application Publication
(10) Pub. No.: US 2019/0031946 A1
(43) Pub. Date: Jan. 31, 2019

(54) METHOD FOR TERTIARY PETROLEUM RECOVERY BY MEANS OF A HYDROPHOBICALLY ASSOCIATING POLYMER

(71) Applicant: BASF SE, Ludwigshafen am Rhein (DE)

(72) Inventors: ROLAND RECHENBACH-KLINKE, Trostberg (DE); Christian BITTNER, Ludwigshafen am Rhein (DE); Tobias ZIMMERMANN, Ludwigshafen am Rhein (DE); Arne STAVLAND, Stavanger (NO)

(21) Appl. No.: 16/069,646

(22) PCT Filed: Jan. 4, 2017
(86) PCT No.: PCT/EP2017/050135

§ 371 Date: Jul. 12, 2018

(30) Foreign Application Priority Data
Jan. 14, 2016 (EP) 16151032.6

(51) Int. Cl. C09K 8/588; C08F 220/56

(52) U.S. Cl. CPC C09K 8/588; C08F 220/06; C08F 220/56

(57) ABSTRACT

A method of tertiary production of mineral oil from underground deposits having a deposit temperature of ≤70° C., in which a copolymer comprising (meth)acrylamide or derivatives thereof, monoethylenically unsaturated carboxylic acids, especially acrylic acid, and an associative monomer is used, wherein the amount of the associative monomer is 0.1% to 0.9% by weight. A water-soluble copolymer comprising (meth)acrylamide or derivatives thereof, monoethylenically unsaturated carboxylic acids, especially acrylic acid, and 0.1% to 0.9% by weight of an associative monomer.

The present invention relates to a method of tertiary production of mineral oil from underground deposits having a deposit temperature of ≤70° C., in which a copolymer comprising (meth)acrylamide or derivatives thereof, monoethylenically unsaturated carboxylic acids, especially acrylic acid, and an associative monomer is used, wherein the amount of the associative monomer is 0.1% to 0.9% by weight. The invention further relates to a water-soluble copolymer comprising (meth)acrylamide or derivatives thereof, monoethylenically unsaturated carboxylic acids, especially acrylic acid, and 0.1% to 0.9% by weight of an associative monomer.

Techniques of tertiary mineral oil production (also known as “enhanced oil recovery (EOR)”) can be used to enhance the oil yield if economically viable mineral oil production is no longer possible on the basis of the intrinsic pressure in the deposit, and even the injection of water or steam alone can no longer achieve any increase in the oil yield.

One of the techniques of tertiary mineral oil production is called “polymer flooding”. Polymer flooding involves injecting an aqueous solution of a thickening polymer into the mineral oil deposit through one or more injection wells, the viscosity of the aqueous polymer solution being matched to the viscosity of the mineral oil. The injection of the polymer solution, as in the case of water flooding, forces the mineral oil through cavities/pores in the deposit from the injection well proceeding in the direction of the production well, and the mineral oil is produced through the production well. By virtue of the polymer formulation having about the same viscosity as the mineral oil, the risk that the polymer formation will break through to the production well with no effect is reduced. Thus, the mineral oil is mobilized much more homogeneously than when water, which is mobile, is used, and additional mineral oil can be mobilized in the formation. Details of polymer flooding and polymers suitable for this purpose are disclosed, for example, in “Petroleum, Enhanced Oil Recovery, Kirk-Othmer, Encyclopedia of Chemical Technology, Online Edition, John Wiley & Sons, 2010”.

Thickening polymers used for polymer flooding are frequently acrylamide-comprising copolymers. Comonomers used may especially be comonomers comprising acid groups, for example acrylic acid or 2-acrylamido-2-methylpropanesulfonic acid (ATBS).

The acrylamide-comprising copolymers may also be hydrophobically associating copolymers. “Hydrophobically associating copolymers” are understood by those skilled in the art to mean water-soluble polymers having lateral or terminal hydrophobic groups, for example relatively long alkyl chains. In an aqueous solution, such hydrophobic groups can associate with themselves or with other substances having hydrophobic groups. This results in formation of an associative network which causes (additional) thickening action. Details of the use of hydrophobically associating copolymers for tertiary mineral oil production are described, for example, in the review article by Taylor, K. C. and Nasr-EI-Din, H. A. in J. Petr. Sci. Eng. 1998, 19, 265-280.

U.S. Pat. No. 4,814,096 discloses a method of tertiary mineral oil production using a hydrophilic polymer having hydrophobic groups and a nonionic surfactant which associates with the hydrophobic groups of the polymer. Table I discloses polymer A composed of about 74% by weight of acrylamide, about 25% by weight of acrylic acid and about 0.36% by weight of dodecyl methacrylate as hydrophobic monomer.

WO 85/03510 A1 discloses water-soluble, hydrophobically associating copolymers having a weight average molecular weight M_{w} of 800 000 g/mol to 3 million g/moll and the use thereof for tertiary mineral oil production. The copolymers comprise 40 to 99.9 mol % of acrylamide, 0 to 50 mol % of acrylic acid and 0.1 to 10 mol % of the macromonomer H₂C═CH—COO-(EO)₅₋₄₀—R where EO represents ethyleneoxy groups and R is an alkyl radical having 8 to 16 carbon atoms.

US 2007/0287815 A1 discloses associative amphoteric polymers having a molecular weight of more than 50 000 g/mol, comprising 1 to 99 mol % of a nonionic water-soluble monomer, 1 to 99.9 mol % of an anionic monomer comprising carboxyl, phosphonate or sulfonate groups, and a cationic monomer of the general formula R¹R²C═C(R³)CON(R⁴)-Q-N⁺(R⁵)(R⁶)(R⁷) X⁻ where R¹ to R⁶ are H or C₁- to C₄-alkyl, Q is an alkyl group having 1 to 8 carbon atoms, X⁻ is an anion and R⁷ is an alkyl or alkylaryl group having 8 to 30 carbon atoms. The amount of the cationic monomer may preferably be 0.005 mol % to 10 mol %.

WO 2010/133527 A2 discloses water-soluble, hydrophobically associating copolymers and the use thereof for tertiary mineral oil production. The copolymers comprise 25% to 99.9% by weight of monoethylenically unsaturated, hydrophilic monomers, for example acrylamide or acrylic acid, and 0.1% to 20% by weight of at least one macromonomer of the general formula H₂C═CH—R—O-(EO)₁₀₋₁₅₀(AO)₅₋₁₅R′where EO represents ethyleneoxy groups, AO represents alkyleneoxy groups having at least 4 carbon atoms, R is a linking group and R′ is H or a hydrocarbyl radical having 1 to 30 carbon atoms.

WO 2012/069477 A1 discloses a method of tertiary mineral oil production from mineral oil formations having a deposit temperature of 35 to 120° C., preferably 40° C. to 90° C., in which a hydrophobically associating copolymer comprising 0.1% to 15% by weight of the above-described macromonomer H₂C═CH—R—O-(EO)₁₀₋₁₅₀(AO)₅₋₁₅R′ and 85% to 99.9% by weight of acrylamide or acrylamide derivatives and monoethylenically unsaturated monomers having COOH, SO₃H or PO₃H₂ groups is used. EO, AO, R and R′ are as defined above. The weight-average molecular weight M_{w} of the copolymer is 1 million to 3 million g/mol. Particular preference is given to a copolymer comprising acrylamide, 2-acrylamido-2-methylpropanesulfonic acid (ATBS) and said macromonomer.

WO 2014/095608 A1 discloses a process for preparing macromonomers H₂C═CH—OR—O-(EO)₁₀₋₁₅₀(AO)₅₋₂₅(EO)₀₋₁₅R′ where DO represents ethyleneoxy groups, AO represents alkyleneoxy groups having at least 4 carbon atoms, R is a linking group and R′ is H or a hydrocarbyl radical having 1 to 4 carbon atoms. The application further discloses copolymers comprising hydrophilic monomers and 0.1% to 20% by weight of the macromonomer described, and the use thereof for oilfield applications.

WO 2014/095621 A1 discloses hydrophobically associating copolymers comprising 25% to 99.9% by weight of at least one hydrophilic monomer, for example acrylamide and/or acrylic acid, and 0.1% to 20% by weight of at least one macromonomer of the general formula H₂C═CH—O—R—O-(EO)₂₃₋₂₆(CH₂CH(R″))_{8.5-17.25}(EO)₀₋₁₅R′ where EO represents ethyleneoxy groups, R is a linking group, R′ is H or a hydrocarbyl radical having 1 to 4 carbon atoms, and R″ is a hydrocarbyl radical having at least 2 carbon atoms, with the proviso that the sum total of the carbon atoms in all the R″ radicals is 25.5 to 34.5.

WO 2015/086486 A1 discloses hydrophobically associating copolymers and the use thereof for tertiary mineral oil production, comprising 30% to 99.99% by weight of acrylamide or derivatives thereof and 0.01% to 15% by weight of monoethylenically unsaturated macromonomers. The latter are a mixture of monomers H₂C═CH—O—R-(EO)ₓ(AO)_{y}H and H₂C═CH—O—R-(EO)ₓ(AO)_{y}(EO/AO)_{z}H, where EO represents ethylene oxide units and AO represents alkylene oxide units. The copolymers may further comprise monomers having acidic groups.

Underground mineral oil deposits generally have a deposit temperature above room temperature; the temperature may, for example, be 40° C. to 120° C. A mineral oil deposit further comprises, as well as mineral oil, typically water with a greater or lesser salt content.

Copolymers comprising acrylamide and ATBS have higher tolerance to high temperatures and/or high salt contents, especially high contents of divalent ions, than copolymers comprising acrylamide and acrylic acid. The former are thus the polymers having higher technical performance. However, ATBS is much more expensive than acrylic acid and, correspondingly, acrylamide-ATBS copolymers are also significantly more expensive than acrylamide-acrylic acid copolymers. Users therefore have a preference for acrylamide-acrylic acid copolymers for deposit conditions that are not too demanding, for reasons of cost.

A higher content of the associative monomers described results in a higher viscosity of the associative polymer. However, it has been found that, surprisingly, copolymers comprising acrylamide, acrylic acid and associative monomers and comprising only a small amount of associative monomers have performance advantages over copolymers having a higher proportion of associative monomers. It has been found that, surprisingly the oil yield of a copolymer comprising only 0.5% by weight of associative monomer is higher than that of an associative monomer comprising 1% by weight of associative monomer.

Accordingly, a method of producing mineral oil from underground mineral oil deposits comprising mineral oil and saline deposit water has been found, in which an aqueous formulation comprising at least one thickening water-soluble copolymer (P) is injected into the mineral oil deposit through at least one injection well and mineral oil is withdrawn from the deposit through at least one production well, wherein the water-soluble copolymer (P) comprises at least
65% to 85% by weight of at least one monomer (A) selected from the group of (meth)acrylamide, N-methyl(meth)acrylamide, N,N′-dimethyl(meth)acrylamide or N-methylol(meth)acrylamide, and
14.9% to 34.9% by weight of at least one monomer (B) selected from the group of acrylic acid, methacrylic acid, crotonic acid, itaconic acid, maleic acid or fumaric acid or salts thereof,
and wherein
the water-soluble copolymer (P) further comprises 0.1% to 0.9% by weight of at least one monoethylenically unsaturated monomer (C) selected from the group of

H₂C═C(R¹)—O—(—CH₂—CH(R⁵)—O—)ₖ—R⁶ (I),

H₂C═C(R¹)—(C═O)—O—(—CH₂—CH(R⁵)—O—)ₖ—R⁶ (II),

H₂C═C(R¹)—R⁷—O—(—CH₂—CH(R⁸)—O—)ₓ—(—CH₂—CH(R⁹)—O—)_{y}—(—CH₂—CH₂O—)_{z}—R¹⁰ (III),

H₂C═C(R¹)—C(═O)O—R¹¹—N⁺(R¹²)(R¹³)(R¹⁴)X⁻ (IV) or

H₂C═C(R¹)—C(═O)N(R¹⁵)—R¹¹—N⁺(R¹²)(R¹³)(R¹⁴)X⁻ (V),
where the radicals and indices are defined as follows:
   R¹: H or methyl;
   R⁵: independently H, methyl or ethyl, with the proviso that at least 70 mol % of the R⁵ radicals are H,
   R⁶: aliphatic and/or aromatic, linear or branched hydrocarbyl radicals having 8 to 40 carbon atoms,
   R⁷: a single bond or a divalent linking group selected from the group consisting of —(CₙH₂ₙ)—, —O—(C_{n′}H_{2n′})— and —C(O)—O—(C_{n′}—H_{2n′})—, where n is a natural number from 1 to 6, and n′ and n″ are a natural number from 2 to 6,
   R⁸: independently H, methyl or ethyl, with the proviso that at least 70 mol % of the R⁸ radicals are H,
   R⁹: independently hydrocarbyl radicals of at least 2 carbon atoms,
   R¹⁰: H or a hydrocarbyl radical having 1 to 30 carbon atoms,
   R¹¹: an alkylene radical having 1 to 8 carbon atoms,
   R¹², R¹³: independently H or an alkyl group having 1 to 4 carbon atoms,
   R¹⁴:
   R¹⁵: aliphatic and/or aromatic, linear or branched hydrocarbyl radicals having 8 to 30 carbon atoms,
   X⁻ a negatively charged counterion,
   k a number from 10 to 80,
   x a number from 10 to 50,
   a number from 5 to 30, and
   z a number from 0 to 10,
the deposit temperature is ≤70° C.,
the permeability of the deposit is ≥100 mD, and
the deposit water comprises not more than 10 g/L of divalent ions.

Additionally found have been water-soluble copolymers (P) comprising at least
65% to 85% by weight of at least one monomer (A) selected from the group of (meth)acrylamide, N-methyl(meth)acrylamide, N,N′-dimethyl(meth)acrylamide or N-methylol(meth)acrylamide, and
14.9% to 34.9% by weight of at least one monomer (B) selected from the group of acrylic acid, methacrylic acid, crotonic acid, itaconic acid, maleic acid or fumaric acid or salts thereof,
and wherein the water-soluble copolymer (P) further comprises 0.1% to 0.9% by weight of at least one monoethylenically unsaturated monomer (C) selected from the group of

H₂C═C(R¹)—O—(—CH₂—CH(R⁵)—O—)ₖ—R⁶ (I),

H₂C═C(R¹)—(C═O)—O—(—CH₂—CH(R⁵)—O—)ₖ—R⁶ (II),

H₂C═C(R¹)—R⁷—O—(—CH₂—CH(R⁸)—O—)ₓ—(—CH₂—CH(R⁹)—O—)_{y}—(—CH₂—CH₂O—)_{z}—R¹⁰ (III),

H₂C═C(R¹)—C(═O)O—R¹¹—N⁺(R¹²)(R¹³)(R¹⁴)X⁻ (IV) or

H₂C═C(R¹)—C(═O)N(R¹⁵)—R¹¹—N⁺(R¹²)(R¹³)(R¹⁴)X⁻ (V),
where the radicals and indices are defined as follows:
   R¹: H or methyl;
   R⁵: independently H, methyl or ethyl, with the proviso that at least 70 mol % of the R⁵ radicals are H,
   R⁶: aliphatic and/or aromatic, linear or branched hydrocarbyl radicals having 8 to 40 carbon atoms,
   R⁷: a single bond or a divalent linking group selected from the group consisting of —(CₙH₂ₙ)—, —O—(C_{n′}H_{2n′})— and —C(O)—O—(C_{n″}H_{2n′}′)—, where n is a natural number from 1 to 6, and n′ and n″ are a natural number from 2 to 6,
   R⁸: independently H, methyl or ethyl, with the proviso that at least 70 mol % of the R⁸ radicals are H,
   R⁹: independently hydrocarbyl radicals of at least 2 carbon atoms,
   R¹⁰: H or a hydrocarbyl radical having 1 to 30 carbon atoms,
   R¹¹: an alkylene radical having 1 to 8 carbon atoms,
   R¹², R¹³, R¹⁴: independently H or an alkyl group having 1 to 4 carbon atoms,
   R¹⁵: aliphatic and/or aromatic, linear or branched hydrocarbyl radicals having 8 to 30 carbon atoms,
   X⁻ a negatively charged counterion,
   k a number from 10 to 80,
   x a number from 10 to 50,
   y a number from 5 to 30, and
   z a number from 0 to 10.

Specific details of the invention are as follows:

Monomers (A)

According to the invention, the water-soluble copolymer (P) comprises at least one uncharged, monoethylenically unsaturated, hydrophilic monomer (A) selected from the group of (meth)acrylamide, N-methyl(meth)acrylamide, N,N′-dimethyl(meth)acrylamide or N-methylol(meth)acrylamide. It is preferably (meth)acrylamide, especially acrylamide. If mixtures of different monomers (A) are used, at least 50 mol % of the monomers (A) should be (meth)acrylamide, preferably acrylamide. In one embodiment of the invention, the monomer (A) is acrylamide.

According to the invention, the amount of the monomers (A) is 65% to 85% by weight, based on the sum total of all monomers in the copolymers (P), preferably 65% to 75% by weight.

Monomers (B)

According to the invention, the copolymer (P) further comprises at least one monomer (B) comprising COOH groups, selected from the group of acrylic acid, methacrylic acid, crotonic acid, itaconic acid, maleic acid or fumaric acid, or salts thereof.

Suitable counterions include especially alkali metal ions such as Li⁺, Na⁺ or K⁺, and ammonium ions such as NH₄⁺ or ammonium ions having organic radicals. Examples of ammonium ions having organic radicals include [NH(CH₃)₃]⁺, [NH₂(CH₃)₂]⁺, [NH₃(CH₃)]⁺, [NH(C₂H₅)₃]⁺, [NH₂(C₂H₅)₂]⁺, [NH₃(C₂H₅)]⁺, [NH₃(CH₂CH₂OH)]⁺, [H₃N—CH₂CH₂—NH_{3]}²⁺ or [H(H₃C)₂N—CH₂CH₂CH₂NH₃]²⁺.

Preference is given to (meth)acrylic acid, especially acrylic acid or salts thereof. If mixtures of different monomers (B) are used, at least 50 mol % of the monomers (B) should be (meth)acrylic acid, preferably acrylic acid.

According to the invention, the amount of the monomers (B) is 14.9% to 34.9% by weight, based on the sum total of all monomers in the copolymer (P), preferably 24.8% to 34.8% by weight.

Monomers (C)

The monomers (C) are monoethylenically unsaturated monomers having at least one hydrophilic group and at least one, preferably terminal, hydrophobic group.

Monomers of this kind have amphiphilic, i.e. interface-active properties, and serve to impart hydrophobic associating properties to the copolymers (P).

“Hydrophobically associating copolymers” are understood by those skilled in the art to mean water-soluble copolymers having, as well as hydrophilic units (in a sufficient amount to assure water solubility), hydrophobic groups in lateral or terminal positions. In aqueous solution, the hydrophobic groups can associate with one another. Because of this associative interaction, there is an increase in the viscosity of the aqueous polymer solution compared to a polymer which is equivalent, except that it has no associative groups.

Suitable monomers (C) may especially have the general formula H₂C═C(R¹)—R²—R³ or H₂C═C(R¹)—R²—R³—R⁴ where R¹ is H or methyl, R² is a linking hydrophilic group, R³ is a hydrophobic group and R⁴ is a hydrophilic group.

The linking hydrophilic R² group may be a group comprising alkylene oxide units, for example a group comprising 5 to 50 alkylene oxide units, bonded to the H₂C═C(R¹)— group in a suitable manner, for example by means of a single bond or a suitable linking group, for example a —C(═O)O— group, where at least 70 mol %, preferably at least 90 mol %, of the alkylene oxide units are ethylene oxide units.

In addition, R² may be a group comprising quaternary ammonium groups. More particularly, a group comprising quaternary ammonium groups may be a —COO—(CH₂)ₙ—N⁺(CH₃)₂— group or a —CON(CH₃)—(CH₂)ₙ—N⁺(CH₃)₂— group where n is 1 to 4.

The hydrophobic R³ group may be aliphatic and/or aromatic, linear or branched C₈₋₄₀-hydrocarbyl R^{3a} radicals, preferably C₁₂₋₃₂-hydrocarbyl radicals. In a further embodiment, the hydrophobic R³ group may be an R^{3b} group comprising alkylene oxide units having at least 3 carbon atoms, preferably at least 4 carbon atoms.

The hydrophilic R⁴ group may especially be a group comprising ethylene oxide groups, especially a group comprising not more than 5 ethylene oxide units.

In a preferred embodiment of the invention, the monomers (C) are monomers of the general formula H₂C═C(R¹)—O—(—CH₂—CH(R⁵)—O—)ₖ—R⁶ (I) or H₂C═C(R¹)—(C═O)—O—(—CH₂—CH(R⁵)—O—)ₖ—R⁶ (II).

In the formulae (I) and (II), R¹ has the definition outlined above. The R⁵ radicals are each independently H, methyl or ethyl, preferably H or methyl, with the proviso that at least 70 mol % of the R⁵ radicals are H. Preferably at least 80 mol % of the R⁵ radicals are H, more preferably at least 90 mol %, and they are most preferably exclusively H. This block is thus a polyoxyethylene block which may optionally include certain proportions of propylene oxide and/or butylene oxide units, preferably a pure polyoxyethylene block.

The number of alkylene oxide units k is a number from 10 to 80, preferably 12 to 60, more preferably 15 to 50 and, for example, 20 to 40. It will be apparent to the person skilled in the art in the field of alkylene oxides that the values mentioned are mean values.

R⁶ is an aliphatic and/or aromatic, straight-chain or branched hydrocarbyl radical having 8 to 40 carbon atoms, preferably 12 to 32 carbon atoms. In one embodiment, the aliphatic hydrocarbyl groups are those having 8 to 22 and preferably 12 to 18 carbon atoms. Examples of such groups include n-octyl, n-decyl, n-dodecyl, n-tetradecyl, n-hexadecyl or n-octadecyl groups. In a further embodiment, the groups are aromatic groups, especially substituted phenyl radicals, especially distyrylphenyl groups and/or tristyrylphenyl groups.

In a further embodiment of the invention, the monomers (C) are monomers of the general formula

H₂C═C(R¹)—R⁷—O—(—CH₂—CH(R⁸)—O—)ₓ—(—CH₂—CH(R⁹)—O—)_{y}—(—CH₂—CH₂O—)_{z}—R¹⁰ (III).

In the monomers (C) of the formula (III), an ethylenic H₂C═C(R²)— group is bonded via a divalent linking —R⁷—O— group to a polyoxyalkylene radical having block structure, where the —(—CH₂—CH(R⁸)—O—)ₓ—, —(—CH₂—CH(R⁹)—O—)ₗ— and optionally —(—CH₂—CH₂O—)_{z}—R¹⁰ blocks are arranged in the sequence shown in formula (III). The transition between the two blocks may be abrupt or else continuous.

In formula (III), R¹ has the definition already defined, i.e. R¹ is H or a methyl group.

R⁷ is a single bond or a divalent linking group selected from the group consisting of —(CₙH₂ₙ)—, —O—(C_{n′}H_{2n′})— and —C(O)—O—(C_{n″}H_{2n′}′)—. In the formulae mentioned, n in each case is a natural number from 1 to 6; n′ and n″ are each a natural number from 2 to 6. In other words, the linking group comprises straight-chain or branched aliphatic hydrocarbyl groups which have 1 to 6 carbon atoms and may be joined directly, via an ether group —O— or via an ester group —C(O)—O— to the ethylenic H₂C═C(R⁵)— group. The —(CₙH₂ₙ)—, —(C_{n′}H_{2n′})— and —(C_{n″}H_{2n″})— groups are preferably linear aliphatic hydrocarbyl groups.

Preferably, the —(CₙH₂ₙ)— group is a group selected from —CH₂—, —CH₂—CH₂— and —CH₂—CH₂—CH₂—, more preferably a methylene group —CH₂—.

Preferably, the —O—(C_{n′}H_{2n′})— group is a group selected from —O—CH₂—CH₂—, —O—CH₂—CH₂—CH₂— and —O—CH₂—CH₂—CH₂—CH₂—, more preferably —O—CH₂—CH₂—CH₂—CH₂—.

Preferably, the —C(O)—O—(C_{n″}H_{2n″})— group is a group selected from —C(O)—O—CH₂—CH₂—, —C(O)O—CH(CH₃)—CH₂—, —C(O)O—CH₂—CH(CH₃)—, —C(O)O—CH₂—CH₂—CH₂—CH₂— and —C(O)O—CH₂—CH₂—CH₂—CH₂—CH₂—CH₂—, more preferably —C(O)—O—CH₂—CH₂— and —C(O)O—CH₂—CH₂—CH₂—CH₂—, and most preferably is —C(O)—O—CH₂—CH₂—.

More preferably, the R⁷ group is a —O—(C_{n′}H_{2n′})— group, most preferably —O—CH₂—CH₂—CH₂—CH₂—.

In the —(—CH₂—CH(R⁸)—O—)ₓ block, the R⁸ radicals are independently H, methyl or ethyl, preferably H or methyl, with the proviso that at least 70 mol % of the R⁸ radicals are H. Preferably at least 80 mol % of the R¹⁰ radicals are H, more preferably at least 90 mol %, and they are most preferably exclusively H. This block is thus a polyoxyethylene block which may optionally include certain proportions of propylene oxide and/or butylene oxide units, preferably a pure polyoxyethylene block.

The number of alkylene oxide units x is a number from 10 to 50, preferably 12 to 40, more preferably 15 to 35, even more preferably 20 to 30 and, for example, 23 to 26. It will be apparent to the person skilled in the art in the field of polyalkylene oxides that the numbers mentioned are mean values of distributions.

In the second —(CH₂—CH(R⁹)—O)_{y}— block, the R⁹ radicals are independently hydrocarbyl radicals of at least 2 carbon atoms, for example 2 to 10 carbon atoms, preferably 2 or 3 carbon atoms. This may be an aliphatic and/or aromatic, linear or branched carbon radical. Preference is given to aliphatic radicals.

Examples of suitable R⁹ radicals include ethyl, n-propyl, n-butyl, n-pentyl, n-hexyl, n-heptyl, n-octyl, n-nonyl or n-decyl and phenyl. Examples of preferred radicals include ethyl, n-propyl, n-butyl, n-pentyl, especially ethyl and/or n-propyl radicals, and more preferably ethyl radicals. The —(—CH₂—CH(R⁹)—O—)_{y}— block is thus a block consisting of alkylene oxide units having at least 4 carbon atoms.

The number of alkylene oxide units y is a number from 5 to 30, preferably 8 to 25.

In formula (III), z is a number from 0 to 10, preferably 0 to 5, i.e. the terminal block of ethylene oxide units is thus only optionally present. In one embodiment of the invention, z is a number >0 to 10, especially >0 to 10 and, for example, 1 to 4.

The R¹⁰ radical is H or a preferably aliphatic hydrocarbyl radical having 1 to 30 carbon atoms, preferably 1 to 10 and more preferably 1 to 5 carbon atoms. R¹⁰ is preferably H, methyl or ethyl, more preferably H or methyl and most preferably H.

In a preferred embodiment of the invention, at least one of the monomers (C) is a monomer of the formula (III).

In a further preferred embodiment of the invention, a mixture of at least two different monomers (C) of the formula (III) is used, where the radicals R¹, R⁷, R⁸, R⁹, R¹⁰ and the indices x and y are the same in each case. In addition, z=0 in one of the monomers, while z is a number >0 to 10, preferably 1 to 4, in the other. Said preferred embodiment is thus a mixture of the following composition:

H₂C═C(R¹)—R⁷—O—(—CH₂—CH(R⁸)—O—)ₓ—(—CH₂—CH(R⁹)—O—)_{y}—H (IIIa) and

H₂C═C(R¹)—R⁷—O—(—CH₂—CH(R⁸)—O—)ₓ—(—CH₂—CH(R⁹)—O—)_{y}—(—CH₂—CH₂O—)_{z}—H (IIIb),

where the radicals and indices have the definition outlined above, including the preferred embodiments thereof, with the proviso that, in the formula (IIIb), z is a number >0 to 10.

Preferably, in the formulae (IIIa) and (IIIb), R¹ is H, R⁷ is —O—CH₂CH₂CH₂CH₂—, R⁸ is H, R⁹ is ethyl, x is 20 to 30, preferably 23 to 26, y is 12 to 25, preferably 14 to 18, and z is 3 to 5.

The monomers (C) of the formulae (I), (II) and (III), the preparation thereof and acrylamide copolymers comprising these monomers and the preparation thereof are known in principle to those skilled in the art, for example from WO 85/03510 A1, WO 2010/1:33527 A1, WO 2012/069478 A1, WO 2014/095608 A1, WO 2014/095621 A1 and WO 2015/086486 A1 and in the literature cited therein.

In a further embodiment, the monomer (C) is a cationic monomer of the general formula H₂C═C(R¹)—C(═O)O—R¹¹—N⁺(R¹²)(R¹³)(R¹⁴)X⁻ (IV) or H₂C═C(R¹)—C(═O)N(R¹⁵)—R¹¹—N⁺(R¹²)(R¹³)(R¹⁴)X⁻ (V).

Monomers of this kind and acrylamide copolymers having such monomers are known and are described, for example, in U.S. Pat. No. 7,700,702 B2.

In the formulae (IV) and (V), R¹ has the definition defined above.

R¹¹ is an alkylene radical, especially a 1, ω-alkylene radical having 1 to 8 carbon atoms, preferably 2 to 4 carbon atoms and especially 2 or 3 carbon atoms. Examples include —CH₂—, —CH₂CH₂—, —CH₂CH₂CH₂— and —CH₂CH₂CH₂CH₂—. Particular preference is given to —CH₂CH₂— and —CH₂CH₂CH₂—.

R¹², R¹³ and R¹⁵ are independently H or an alkyl group having 1 to 4 carbon atoms, preferably H or methyl. X⁻ is a negatively charged counterion, especially a halide ion selected from F⁻, Cl⁻, Br⁻ or I⁻, preferably Cl⁻ and/or Br.

R¹⁴ is an aliphatic and/or aromatic, linear or branched hydrocarbyl group having 8 to 30 carbon atoms, preferably 12 to 18 carbon atoms. R¹⁶ may especially be aliphatic hydrocarbyl radicals having 8 to 18, preferably 12 to 18, carbon atoms. Examples of such groups include n-octyl, n-decyl, n-dodecyl, n-tetradecyl, n-hexadecyl or n-octadecyl groups, preference being given to n-dodecyl, n-tetradecyl, n-hexadecyl or n-octadecyl groups.

Preference is given to a monomer of the general formula (V). Examples of such monomers include N-(meth)acrylamidopropyl-N,N-dimethyl-N-dodecylammonium chloride, N-(meth)acrylamidopropyl-N,N-dimethyl-N-tetradecylammonium chloride, N-(meth)acrylamidopropyl-N,N-dimethyl-N-hexadecylammonium chloride or N-(meth)acrylamidopropyl-N,N-dimethyl-N-octadecylammonium chloride, or the corresponding bromides.

According to the invention, the amount of the monomers (C) is 0.1% to 0.9% by weight based on the sum total of all the monomers in the copolymer (P), preferably 0.2% to 0.8% by weight, more preferably 0.3% to 0.7% by weight and, for example, 0.4% to 0.6% by weight.

In one embodiment of the invention, the monomers (C) are monomers selected from the group of the monomers of the general formula (I), (II), (III), (IV) and (V).

In one embodiment of the invention, the monomers (C) are monomers selected from the group of the monomers of the general formula (I), (II) and (III).

In one embodiment of the invention, the monomers (C) are monomers of the general formula (III).

In one embodiment of the invention, the monomers (C) are at least two different monomers of the general formula (III), more preferably a mixture comprising at least the monomers (IIIa) and (IIIb).

Further Monomers:

The water-soluble copolymer (P) may, as well as the monomers (A), (B) and (C), optionally comprise further monomers in an amount of not more than 25% by weight. With further monomers of this kind, it is possible to optimally adjust the properties of the copolymer (P) to the particular application.

Further monomers may especially be hydrophilic monomers.

Suitable hydrophilic monomers may be miscible with water in any ratio. In general, the solubility of water at room temperature should be at least 50 g/L, preferably at least 100 g/L.

Further monomers may, for example, be nonionic monomers other than the monomers (A). Examples include monomers comprising hydroxyl and/or ether groups, for example hydroxyethyl (meth)acrylate, hydroxypropyl (meth)acrylate, allyl alcohol, hydroxyvinyl ethyl ether, hydroxyvinyl propyl ether, hydroxyvinyl butyl ether, N-vinyl derivatives, for example N-vinylformamide, N-vinylacetamide, N-vinylpyrrolidone or N-vinylcaprolactam, and also vinyl esters, for example vinyl formate or vinyl acetate. N-Vinyl derivatives may, after polymerization, be hydrolyzed to vinylamine units, and vinyl esters to vinyl alcohol units.

Further monomers may also be monomers comprising acid groups other than the monomers (B), for example monomers comprising sulfonic acid groups or phosphonic acid groups or salts thereof.

Examples of monomers comprising sulfonic acid groups include vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid. Preference is given to vinylsulfonic acid, allylsulfonic acid or 2-acrylamido-2-methylpropanesulfonic acid, and particular preference is given to 2-acrylamido-2-methylpropanesulfonic acid.

Examples of monomers comprising phosphonic acid groups comprise vinylphosphonic acid, allylphosphonic acid, N-(meth)acrylamidoalkylphosphonic acids or (meth)acryloyloxyalkylphosphonic acids, preference being given to vinylphosphonic acid.

The acidic groups may of course have been wholly or partly neutralized, meaning that they may be present in the form of salts. Suitable counterions for the acidic group especially include alkali metal ions such as Li⁺, Na⁺ or K⁺, and ammonium ions NH₄⁺ and ammonium ions having organic radicals. Examples of organic ammonium ions have already been mentioned above.

The amount of further monomers in addition to the monomers (A), (B) and (C) is not more than 25% by weight based on the amount of all the monomers used, especially not more than 15% by weight, preferably not more than 10% by weight, more preferably not more than 5% by weight, and most preferably no further monomers are present in the copolymer aside from the monomers (A), (B) and (C), meaning that the sum total of the monomers (A), (B) and (C) is 100% by weight.

Preparation of the Copolymers

The copolymers of the invention can be prepared by methods known in principle to the person skilled in the art by free-radical polymerization of the monomers (A), (B), (C) and optionally further monomers in aqueous solution, for example by means of solution polymerization, gel polymerization or inverse emulsion polymerization. The polymerization techniques mentioned are known in principle to those skilled in the art.

For polymerization, aqueous solutions or of the monomers can be used and polymerized together with suitable initiators for free-radical polymerization. The polymerization can be effected by thermal and/or photochemical means. It is of course possible to use further additives and auxiliaries, for example defoamers or complexing agents, for polymerization.

The polymerization can especially be effected by means of gel polymerization.

In a preferred embodiment of the invention, the copolymers used are prepared in the presence of at least one non-polymerizable surface-active compound (T).

Details of gel polymerization, preferred reactors and auxiliaries are given in detail in WO 2015/086468 A1, page 24 line 24 to page 30 line 15.

The copolymers (P) are water-soluble. They may preferably be miscible with water in any ratio. The minimum requirement is that they are soluble in water under use conditions, i.e. at the concentrations and temperatures at which they are used.

The copolymers (P) obtained generally have a weight-average molecular weight M_{w} of 1*10⁶ g/mol to 30*10⁶ g/mol, preferably 6*10⁶ g/mol to 25*10⁶ g/mol and, for example, 8*10⁶ g/mol to 20*10⁶ g/mol.

Method of Tertiary Mineral Oil Production

To execute the method of the invention, at least one production well and at least one injection well are sunk into the mineral oil deposit. In general, a deposit is provided with several injection wells and with several production wells. An aqueous formulation of the water-soluble copolymer (P) described is injected through the at least one injection well into the mineral oil deposit, and mineral oil is withdrawn from the deposit through at least one production well. As a result of the pressure generated by the aqueous formulation injected, called the “polymer flood”, the mineral oil flows in the direction of the production well and is produced via the production well. As well as mineral oil, water is generally also produced, especially deposit water, and deposit water mixed with injected aqueous liquids.

The deposit temperature of the mineral oil deposit in which the method of the invention is employed is, in accordance with the invention, not more than 70° C., for example 20° C. to 70° C., especially 35° C. to 70° C., preferably 40° C. to 70° C., for example 45° C. to 65° C. or 50° C. to 70° C.

It will be clear to the person skilled in the art that a mineral oil deposit may also have a certain temperature distribution. Said deposit temperature is based on the region of the deposit between the injection and production wells which is covered by the polymer flooding. Methods of determining the temperature distribution of a mineral oil deposit are known in principle to those skilled in the art. The temperature distribution is generally determined from temperature measurements at particular sites in the formation in combination with simulation calculations; the simulation calculations also take account of the amounts of heat introduced into the formation and the amounts of heat removed from the formation.

The average permeability of the mineral oil deposit at which the method of the invention is employed is more than 100 mD (9.87*10⁻¹⁴ m²). The permeability of a mineral oil formation is reported by the person skilled in the art in the unit “darcy” (abbreviated to “D” or “mD” for “millidarcies”, 1 D=9.86923*10⁻¹³ m²), and can be determined from the flow rate of a liquid phase in the mineral oil formation as a function of the pressure differential applied. The flow rate can be determined in core flooding tests with drill cores taken from the formation. Details of this can be found, for example, in K. Weggen, G. Pusch, H. Rischmüller in “Oil and Gas”: pages 37 ﬀ., Ullmann's Encyclopedia of Industrial Chemistry, Online Edition, Wiley-VCH, Weinheim 2010. It will be clear to the person skilled in the art that the permeability in a mineral oil deposit need not be homogeneous, but generally has a certain distribution, and the permeability reported for a mineral oil deposit is accordingly an average permeability.

The method of the invention can especially be employed in the case of mineral oil deposits having an average permeability of 100 mD (9.87*10⁻¹⁴ m²) to 4 D (3.95*10⁻¹² m²), preferably 200 mD (1.97*10⁻¹³ m²) to 2 D (1.97*10⁻¹² m²) and more preferably 200 mD (1.97*10⁻¹³ m²) to 1 D (9.87*10⁻¹³ m²).

The deposits in which the method of the invention is employed comprise, as well as mineral oil, saline deposit water. Salts in the deposit water include, in a manner known in principle, monovalent ions such as Na⁺, K⁺ and divalent ions such as Ca²⁺ or Mg²⁺.

According to the invention, the deposit water comprises not more than 10 g/L of divalent ions, for example 0.01 g/L to 10 g/L of divalent ions. More particularly, the amount of divalent ions is 0.1 to 10 g/L, preferably 0.1 to 5 g/L and, for example, 0.2 to 2 g/L.

The total amount of all the salts in the aqueous formulation may be up to 350 000 ppm (parts by weight), based on the sum total of all the components in the formulation, for example 2000 ppm to 350 000 ppm. The total amount of all salts is preferably 2000 ppm to 100 000 ppm, especially 2000 ppm to 60 000 ppm and, for example, 30 000 ppm to 40 000 ppm.

The mineral oil in the deposit may in principle be any kind of mineral oil. In one embodiment of the invention, the mineral oil comprises medium-heavy and heavy oils. The terms “heavy”, “medium-heavy” and “light” relate to the density of mineral oil, which is typically reported in API gravity in the mineral oil industry, according to the following relationship: API gravity=(141.5/ρᵣₑₗ)−131.5, where ρᵣₑₗ is the relative density of the mineral oil at 15 5/9° C. (based on the density of water under the same conditions). In one embodiment, the oils are those of <35° API, for example 22° to 35° API. In a further embodiment, the oils are those of <22° API, for example 2 to 22 API.

To execute the method, an aqueous formulation comprising, as well as water, at least the copolymer (P) described is used. It is of course also possible to use mixtures of different copolymers (P).

The formulation can be made up in fresh water, but also in water comprising salts. Of course, they may be mixtures of different salts. For example, it is possible to use seawater to make up the aqueous formulation, or it is possible to use produced formation water, which is reused in this way. In the case of offshore production platforms, the formulation is generally made up in seawater. In the case of onshore production facilities, the polymer can advantageously first be dissolved in fresh water and the solution obtained can be diluted to the desired use concentration with formation water.

The aqueous formulation may of course comprise further components.

Examples of further components include biocides, stabilizers, free-radical scavengers, inhibitors, surfactants, cosolvents, bases or complexing agents.

Surfactants and/or bases can be used, for example, in order to promote the deoiling effect of the copolymers (P). Examples of suitable surfactants include surfactants comprising sulfate groups, sulfonate groups, polyoxyalkylene groups, anionically modified polyoxyalkylene groups, betaine groups, glucoside groups or amine oxide groups, for example alkylbenzenesulfonates, olefinsulfonates, amidopropyl betaines, alkyl polyglucosides, alkyl polyalkoxylates or alkyl polyalkoxysulfates, -sulfonates or -carboxylates. It is possible with preference to use anionic surfactants, optionally in combination with nonionic surfactants.

Additives can be used, for example, in order to prevent unwanted side effects, for example the unwanted precipitation of salts, or in order to stabilize the copolymer (P) used. The polymer formulations injected into the formation in polymer flooding flow only very gradually in the direction of the production well, meaning that they remain for a prolonged period of the formation, in the course of which they are exposed to the conditions that exist in the formation, for example elevated temperature and high salt contents. There is the risk here that the polymers will be degraded. Degradation of the polymer results in a decrease in the viscosity. This either has to be taken into account through the use of a higher amount of polymer, or else it has to be accepted that the efficiency of the method will worsen. In each case, the economic viability of the method worsens. A multitude of mechanisms may be responsible for the degradation of the polymer. By means of suitable additives, the polymer degradation can be prevented or at least delayed according to the conditions.

In one embodiment of the invention, the aqueous formulation used comprises at least one oxygen scavenger. Oxygen scavengers react with oxygen which may possibly be present in the aqueous formulation and thus prevent the oxygen from being able to attack the polymer. Examples of oxygen scavengers include sulfites, for example Na₂SO₃, bisulfites or dithionites. In a further embodiment of the invention, the aqueous formulation used comprises at least one free radical scavenger. Free radical scavengers can be used to counteract the degradation of the polymer by free radicals. Compounds of this kind can form stable compounds with free radicals. Free radical scavengers are known in principle to those skilled in the art. For example, they may be stabilizers selected from the group of sulfur compounds, sterically hindered amines, N-oxides, nitroso compounds, aromatic hydroxyl compounds or ketones. Examples of sulfur compounds include thiourea, substituted thioureas such as N,N′-dimethylthiourea, N,N′-diethylthiourea, N,N′-diphenylthiourea, thiocyanates, for example ammonium thiocyanate or potassium thiocyanate, tetramethylthiuram disulfide, and mercaptans such as 2-mercaptobenzothiazole or 2-mercaptobenzimidazole or salts thereof, for example the sodium salts, sodium dimethyldithiocarbamate, 2,2′-dithiobis(benzothiazole), 4,4′-thiobis(6-t-butyl-m-cresol). Further examples include dicyandiamide, guanidine, cyanamide, paramethoxyphenol, 2,6-di-t-butyl-4-methylphenol, butylhydroxyanisole, 8-hydroxyquinoline, 2,5-di(t-amyl)-hydroquinone, 5-hydroxy-1,4-naphthoquinone, 2,5-di(t-amyl)hydroquinone, dimedone, propyl 3,4,5-trihydroxybenzoate, ammonium N-nitrosophenylhydroxylamine, 4-hydroxy-2,2,6,6-tetramethyloxypiperidine, N-(1,3-dimethylbutyl)-N′-phenyl-p-phenylenediamine and 1,2,2,6,6-pentamethyl-4-piperidinol. Preference is given to sterically hindered amines such as 1,2,2,6,6-pentamethyl-4-piperidinol and sulfur compounds, mercapto compounds, especially 2-mercaptobenzothiazole or 2-mercaptobenzimidazole or salts thereof, for example the sodium salts, and particular preference is given to 2-mercaptobenzothiazole or salts thereof.

In a further embodiment of the invention, the aqueous formulation used comprises at least one sacrificial reagent. Sacrificial reagents can react with free radicals and thus render them harmless. Examples include especially alcohols. Alcohols can be oxidized by free radicals, for example to ketones. Examples include monoalcohols and polyalcohols, for example 1-propanol, 2-propanol, propylene glycol, glycerol, butanediol or pentaerythritol.

In a further embodiment of the invention, the aqueous formulation used comprises at least one complexing agent. It is of course possible to use mixtures of various complexing agents. Complexing agents are generally anionic compounds which can complex especially divalent and higher-valency metal ions, for example Mg²⁺ or Ca²⁺. In this way, it is possible, for example, to prevent any unwanted precipitation. In addition, it is possible to prevent any polyvalent metal ions present from crosslinking the polymer by means of acidic groups present, especially COOH group. The complexing agents may especially be carboxylic acid or phosphonic acid derivatives. Examples of complexing agents include ethylenediaminetetraacetic acid (EDTA), ethylenediaminesuccinic acid (EDDS), diethylenetriaminepentamethylenephosphonic acid (DTPMP), methylglycinediacetic acid (MGDA) and nitriloacetic acid (NTA). Of course, the corresponding salts of each may also be involved, for example the corresponding sodium salts.

As an alternative to or in addition to the abovementioned chelating agents, it is also possible to use polyacrylates.

In a further embodiment of the invention, the formulation comprises at least one organic cosolvent. These are preferably completely water-miscible solvents, but it is also possible to use solvents having only partial water miscibility. In general, the solubility should be at least 50 g/L, preferably at least 100 g/L. Examples include aliphatic C₄ to C₈ alcohols, preferably C₄ to C₆ alcohols, which may be substituted by 1 to 5, preferably 1 to 3, ethyleneoxy units to achieve sufficient water solubility. Further examples include aliphatic diols having 2 to 8 carbon atoms, which may optionally also have further substitution. For example, the cosolvent may be at least one selected from the group of 2-butanol, 2 methyl-1-propanol, butylglycol, butyldiglycol and butyltriglycol.

The concentration of the copolymer in the aqueous formulation is fixed such that the aqueous formulation has the desired viscosity for the end use. The viscosity of the formulation should generally be at least 5 mPas (measured at 25° C. and a shear rate of 7 s⁻¹), preferably at least 10 mPas.

In general, the concentration of the water-soluble copolymer (P) in the formulation is 0.02% to 2% by weight, based on the sum total of all the components of the aqueous formulation. The amount is preferably 0.05% to 0.5% by weight, more preferably 0.1% to 0.3% by weight and, for example, 0.1% to 0.2% by weight.

If the copolymer (P) is in the form of powder or granules, the copolymers have to be dissolved in the aqueous medium for injection. Granules may, for example, have an average particle size of 0.1 mm to 3 mm. The person skilled in the art is aware that excessive shear stresses should be avoided in the dissolution of high molecular weight polymers, in order to avoid degradation of the polymers. Apparatuses and methods for dissolving polymers and injecting the aqueous solutions into underground formations are known in principle to those skilled in the art.

The aqueous formulation can be prepared by initially charging the water, sprinkling the copolymer in as a powder or granules and mixing it with the water.

In a further embodiment of the invention, the dissolution of copolymer granules or powders can be effected by means of a two-stage method. This involves, in a first dissolution stage, dissolving polymer granules or powder in an aqueous medium to obtain a concentrate. Such a concentrate may have, for example, a concentration of 1% by weight to 3% by weight. This can be effected, for example, in appropriate dissolution tanks. The concentrate is diluted to use concentration in a second stage. This can be effected by injecting the concentrate directly into the pipeline containing the injection fluid. For rapid mixing, a mixer, especially a static mixer, may be disposed beyond the injection site. Such a method is disclosed in WO 2012/140092 A1.

In a further embodiment of the invention, the dissolution can be effected by moistening the polymer granules in a first step with an aqueous phase. In this case, the polymer swells in the aqueous phase. The concentration of the polymer may, for example, be about 2% to 10% by weight, based on the total amount of aqueous phase and polymer. The swollen polymer is subsequently comminuted by means of a suitable comminuting apparatus, for example to a size of 0.05 mm to 0.2 mm, and mixed with further water. This gives rise to a polymer dispersion which may have, for example, a concentration of 1% to 3% by weight of polymer. The polymer dispersion can be fully dissolved in further dissolution tanks. In one variant, it is possible to dispense with dissolution tanks and inject the polymer dispersion directly into the pipeline containing the injection liquid, where the polymer dissolves fully on the way to the injection site. The latter is advantageous especially when the injection fluid still has to be transported over a certain distance in the pipeline, for example from a central dissolution station on the oil field to various injection wells. Suitable apparatuses for the process outlined are disclosed, for example, WO 2008/071808 A1 and WO 2008/081048 A1.

If the copolymer (P) is already in the form of a solution or inverse emulsion, it is optionally mixed with further components and diluted to the use concentration. Such a dilution can also be effected in two stages, by first producing a concentrate and then diluting it further. A suitable apparatus for this purpose is disclosed, for example, by EP 2 283 915 A1.

The injecting of the aqueous formulation can be undertaken by means of customary apparatuses. The formulation can be injected into one or more injection wells by means of customary pumps. The injection wells are typically lined with steel tubes cemented in place, and the steel tubes are perforated at the desired point. The formulation enters the mineral oil formation from the injection well through the perforation. The pressure applied by means of the pumps, in a manner known in principle, is used to fix the flow rate of the formulation and hence also the shear stress with which the aqueous formulation enters the formation.

In general, what is withdrawn from the production well in the method of the invention is not single-phase oil but a crude oil/water emulsion. The term “crude oil/water emulsion” here shall encompass both water-in-oil and oil-in-water emulsions. The oil-water emulsions may comprise, for example, from 0.1 to 99% by weight of water. The water may be saline deposit water. With increasing duration of polymer injection, the water produced may also comprise the injected copolymers.

For further processing of the crude oil in the refinery, the crude oil/water emulsion produced has to be separated. For this purpose, demulsifiers can be added to the oil/water emulsion in a manner known in principle.

Apparatuses and processes for splitting crude oil emulsions are known to those skilled in the art. The emulsion is typically split on site, i.e. still on the oilfield. There may be one apparatus at a production well or a central apparatus in which the splitting of the crude oil emulsions is undertaken for several production wells of an oilfield together.

Alkali/Polymer Flooding

In one embodiment of the invention, the method of the invention comprises alkali/polymer flooding.

For alkali/polymer flooding, an aqueous formulation comprising, as well as water, at least the water-soluble copolymer (P) described and at least one base is used. The pH of the aqueous formulation is generally at least 8, preferably at least 9, especially 9 to 13, preferably 10 to 12 and, for example, 10.5 to 11.

In principle, it is possible to use any kind of base with which the desired pH can be attained, and the person skilled in the art will make a suitable selection. Examples of suitable bases include alkali metal hydroxides, for example NaOH or KOH, or alkali metal carbonates, for example Na₂CO₃. In addition, the bases may be basic salts, for example alkali metal salts of carboxylic acids, phosphoric acid, or especially complexing agents comprising acidic groups in the base form, such as EDTANa₄.

The addition of a base has the effect that additional mineral oil can be mobilized. Mineral oil typically comprises various carboxylic acids, for example naphthenic acids, which are converted to the corresponding salts by the basic formulation. The salts act as naturally occurring surfactants and thus support the process of oil removal.

With regard to further details of the method and the aqueous formulations used, reference is made to the above description. The formulations used for alkali/polymer flooding may be the above-described formulations, including the preferred embodiments, with the proviso that the formulation additionally comprises at least one base and has the pH described above.

In one embodiment of the invention, the formulation used for alkali/polymer flooding additionally comprises at least one complexing agent. In this way, it is advantageously possible to prevent unwanted precipitation of sparingly soluble salts, especially Ca and Mg salts, when the alkaline aqueous formulation comes into contact with the corresponding metal ions and/or aqueous formulations for the method comprising corresponding salts are used. The amount of complexing agents is selected by the person skilled in the art. It may, for example, be 0.1% to 4% by weight, based on the sum total of all the components of the aqueous formulation.

Alkali/Surfactant/Polymer Flooding

In a further embodiment of the invention, the method of the invention comprises alkali/surfactant/polymer flooding.

For alkali/surfactant/polymer flooding, an aqueous formulation comprising, as well as water, at least the copolymer (P) described, at least one base and at least one surfactant is used. The pH of the aqueous formulation is at least 8, preferably at least 9, especially 9 to 13, preferably 10 to 12 and, for example, 10.5 to 11.

Suitable bases have already been mentioned above.

Surfactants used may in principle be any surfactants suitable for surfactant flooding. Surfactants of this kind are known in principle to those skilled in the art. Examples of suitable surfactants for surfactant flooding include surfactants comprising sulfate groups, sulfonate groups, polyoxyalkylene groups, anionically modified polyoxyalkylene groups, betaine groups, glucoside groups or amine oxide groups, for example alkylbenzenesulfonates, olefinsulfonates, amidopropyl betaines, alkyl polyglucosides, alkyl polyalkoxylates or alkyl polyalkoxysulfates, -sulfonates or -carboxylates. It is possible with preference to use anionic surfactants, optionally in combination with nonionic surfactants.

Preference is given to using, for example, the surfactants described in WO 2015/086468 A1, page 44 line 8 to page 48 line 15.

The concentration of the surfactants is generally 0.01% by weight to 2% by weight, preferably 0.05% by weight to 1% by weight and, for example, 0.1% to 0.8% by weight, based on the sum total of all components of the aqueous formulation.

Combined Method

The method of the invention can of course be combined with further method steps.

In one embodiment, the method can be combined with water flooding. In the case of water flooding, water is injected into a mineral oil deposit through at least one injection well, and crude oil is withdrawn from the deposit through at least one production well. The water may be freshwater or saline water such as seawater or deposit water. After the water flooding, the polymer flooding method of the invention may be employed.

In a further embodiment, the method can also be combined with surfactant flooding. In the case of surfactant flooding, an aqueous surfactant solution is injected into a mineral oil deposit through at least one injection well, and crude oil is withdrawn from the deposit through at least one production well. The water may be freshwater or saline water such as seawater or deposit water. The surfactants may be the abovementioned surfactants, including the preferred surfactants described. The aqueous solution may also additionally comprise a base. Possible process sequences are water flooding→surfactant flooding→polymer flooding or water flooding→alkali/surfactant flooding→polymer flooding.

It is of course also possible to employ the method of the invention repeatedly in succession with varying aqueous formulations. For example, the concentration of the polymer in the formulation can be increased stepwise. A combination may additionally comprise, as the first step, alkali/surfactant flooding, followed by polymer flooding without surfactant and alkali as the second step.

A further embodiment comprises, as the first step, alkali/surfactant/polymer flooding, followed by polymer flooding without surfactant and alkali as the second step.

A further embodiment comprises, as the first step, surfactant/polymer flooding, followed by polymer flooding without surfactant as the second step.

In each of the latter two combinations, it is possible in the first step to use aqueous formulations having higher salinity than in the second step. Alternatively, both steps can also be conducted with water of equal salinity.

A further embodiment comprises the pumping of the aqueous polymer solution in the presence of or alternately with gases (e.g. nitrogen, methane, ethane, propane, butane or carbon dioxide). This method can optionally be conducted in the presence of surfactants.

In a further embodiment, it is possible to alternately inject the polymer of the invention with associative monomers and a polymer without associative monomers. The procedure here may be to first of all inject a non-associative polymer which can be well adsorbed on the rock surface of the formation. Subsequently, a solution of the polymer to be used in accordance with the invention can be injected. Further details of this method are described, for example, by US 2011/0180255 A1.

### ADVANTAGES OF THE METHOD OF THE INVENTION

In the case of polymers according to prior art having a comparatively high content of associative monomers, there is the risk that the copolymers can block the formation. This reduces the oil yield. This is avoided through the use of the inventive polymers having a comparatively low content of associative monomers.

It has additionally been found that, surprisingly, the water-soluble copolymers (P) described have temperature-switchable characteristics in core flooding tests. The copolymers (P) lead to comparatively low resistance factors (RF; as defined in the experimental) at low temperature in the core flooding test, which promotes the injectivity of these polymers into the porous medium of the underground rock formation. In the formation, the polymer solution warms up gradually until the corresponding reservoir temperature of, for example, 60° C. has been attained. With the increase in temperature, there is also a rise in the resistance factor (RF), and this leads to balancing of the heterogeneity in the rock channels. This in turn improves the “sweep efficiency” and hence the oil production.

The examples which follow are to illustrate the invention in detail:

TABLE 1
Polymers examined

| | | Intrinsic |
|---|---|---|
| | | viscosity |
| Polymer name | Composition | [dL/g] |
| Polymer A | 70% by weight of acrylamide | about 24 |
| (comparative) | 30% by weight of sodium acrylate | |
| Polymer B | 50% by weight of acrylamide | about 16 |
| (comparative) | 48% by weight of sodium 2-acrylamido-2- | |
| | methylpropanesulfonate | |
| | 2% by weight of HBVE - 24.5 EO - | |
| | 16 BuO - 3.5 EO | |
| Polymer C | 69% by weight of acrylamide | about 24 |
| (comparative) | 30% by weight of sodium acrylate | |
| | 1% by weight of HBVE - 24.5 EO - | |
| | 16 BuO - 3.5 EO | |
| Polymer D | 69.5% by weight of acrylamide | about 24 |
| (inventive) | 30% by weight of sodium acrylate | |
| | 0.5% by weight of HBVE - 24.5 EO - | |
| | 16 BuO - 3.5 EO | |

Preparation of the Macromonomer HBVE-24.5 EO-16 BuO-3.5 EO

First Stage

HBVE-24.5 EO

A 2 L pressure autoclave with anchor stirrer was initially charged with 135.3 g (1.16 mol) of hydroxybutyl vinyl ether (HBVE) (stabilized with 100 ppm of potassium hydroxide (KOH)) and the stirrer was switched on. 1.06 g of potassium methoxide (KOMe) solution (32% KOMe in methanol (MeOH), corresponding to 0.0048 mol of potassium) were fed in and the stirred vessel was evacuated to a pressure less than 10 mbar, heated to 80° C. and operated at 80° C. and a pressure of less than 10 mbar for 70 min. MeOH was distilled off.

In an alternative procedure, the potassium methoxide (KOMe) solution (32% KOMe in methanol (MeOH)) was fed in and the stirred vessel was evacuated to a pressure of 10-20 mbar, heated to 65° C. and operated at 65° C. and a pressure of 10-20 mbar for 70 min. MeOH was distilled off.

The mixture was purged three times with N₂ (nitrogen). Thereafter, the vessel was checked for pressure retention, 0.5 bar gauge (1.5 bar absolute) was set and the mixture was heated to 120° C. The mixture was decompressed to 1 bar absolute and 1126 g (25.6 mol) of ethylene oxide (EO) were metered in until pₘₐₓ was 3.9 bar absolute and Tₘₐₓ was 150° C. After 300 g of EO had been metered in, the metered addition was stopped (about 3 h after commencement) for a wait period of 30 min and the mixture was decompressed to 1.3 bar absolute. Thereafter, the rest of the EO was metered in. The metered addition of EO including the decompression took a total of 10 h.

Stirring was continued to constant pressure at approx. 145-150° C. (1 h), and the mixture was cooled to 100° C. and freed of low boilers at a pressure of less than 10 mbar for 1 h. The material was transferred at 80° C. under N₂.

Second Stage

HBVE-24.5 EO-16 BuO-3.5 EO

The starting material used was HBVE-24.5 EO as described above.

A 2 L pressure autoclave with anchor stirrer was initially charged with 568.6 g (0.525 mol) of HBVE-22 EO and the stirrer was switched on. Thereafter, 2.31 g of 50% NaOH solution (0.029 mol of NaOH, 1.16 g of NaOH) were added, a reduced pressure of <10 mbar was applied, and the mixture was heated to 100° C. and kept there for 80 min, in order to distill off the water.

The mixture was purged three times with N₂. Thereafter, the vessel was tested for pressure retention, 0.5 bar gauge (1.5 bar absolute) was set, the mixture was heated to 127° C. and then the pressure was set to 3 bar absolute. 57.7 g (1.311 mol) of EO were metered in at 127° C.; pₘₐₓ was 6 bar absolute. After waiting for 30 min for establishment of constant pressure, the mixture was decompressed to 4.0 bar absolute. 604.2 g (8.392 mol) of BuO were metered in at 127° C.; pₘₐₓ was 6 bar absolute. One intermediate decompression was necessary owing to increasing fill level. The BuO metering was stopped, and the mixture was left to react for 1 h until pressure was constant and decompressed to 4.0 bar absolute. Thereafter, the metered addition of BuO was continued. Pₘₐₓ was still 6 bar (first decompression after 505 g of BuO, total BuO metering time 11 h incl. decompression break). After metered addition of BuO had ended, reaction was allowed to continue at 127° C. for 6 h. The autoclave was decompressed to 4 bar absolute.

Thereafter, 80.8 g (1.836 mol) of EO were metered in at 127° C.; pₘₐₓ was 6 bar absolute. After metered addition of EO had ended, reaction was allowed to continue for 4 h. The mixture was cooled to 100° C., and residual oxide was drawn off until the pressure was below 10 mbar for at least 10 min. About 1400 ppm of volatile components were removed. Then 0.5% water was added at 120° C. and volatiles were subsequently drawn off until the pressure was below 10 mbar for at least 10 min. The vacuum was broken with N₂ and 100 ppm of BHT were added. The transfer was effected at 80° C. under N₂.

Preparation of Polymer A:

A plastic bucket with a magnetic stirrer, pH meter and thermometer was initially charged with 102.3 g of a 35% aqueous solution of sodium acrylate and then the following were added in succession: 115.7 g of distilled water, 0.4 g of a commercial silicone-based defoamer (Dow Corning® Antifoam Emulsion RD), 168.8 g of acrylamide (50% solution in water), 1.2 g of a 5% aqueous solution of diethylenetriaminepentaacetic acid pentasodium salt, and 4 g of a 4% solution (dissolved in 5% sodium hydroxide solution) of the azo initiator 4,4′-azobis(4-cyanovaleric acid).

After adjustment to pH 6.75 by means of 10% sulfuric acid, the rest of the water was added to attain the target monomer concentration of 30% (total amount of water minus the amount of water already added, minus the amount of acid required), and the monomer solution was adjusted to the initiation temperature of 4° C. The solution was transferred to a thermos flask, the temperature sensor for the temperature recording was attached, the mixture was purged with nitrogen for 45 minutes and the polymerization was initiated with 4 g of a 4% methanolic solution of the azo initiator azobis(isobutyronitrile), 0.16 mL of a 1% t-BHPO solution and 0.16 mL of a 1% sodium bisulfite solution. With the onset of the polymerization, the temperature rose to 80-90° C. within about 25-30 min. On attainment of the temperature maximum, the polymer was stored at 80° C. for 2 hours. After cooling to about 50° C., the gel block was comminuted with the aid of a meat grinder, and the gel granules obtained were dried in a fluidized bed drier at 55° C. for two hours. Hard white granules were obtained, which were converted to a pulverulent state by means of a centrifugal mill.

Preparation of Polymer B:

A plastic bucket with a magnetic stirrer, pH meter and thermometer was initially charged with 146.5 g of a 50% aqueous solution of sodium ATBS and then the following were added in succession: 105 g of distilled water, 0.4 g of a commercial silicone-based defoamer (Dow Corning® Antifoam Emulsion RD), 2.8 g of macromonomers, 138.2 g of acrylamide (50% solution in water), 1.2 g of a 5% aqueous solution of diethylenetriaminepentaacetic acid pentasodium salt, and 3.0 g of the nonionic surfactant iC₁₃-(EO)₁₅H.

After adjustment to pH 6 by means of 20% sodium hydroxide solution and addition of the rest of the water to attain the target monomer concentration of 37% (total amount of water minus the amount of water already added, minus the amount of acid required), the monomer solution was adjusted to the initiation temperature of 4° C. The solution was transferred to a thermos flask, the temperature sensor for the temperature recording was attached, the mixture was purged with nitrogen for 45 minutes and the polymerization was initiated with 1.6 mL of a 10% aqueous solution of the aqueous azo initiator 2,2′-azobis(2-methylpropionamidine) dihydrochloride (Wako V-50), 0.12 mL of a 1% t-BHPO solution and 0.24 mL of a 1% sodium sulfite solution. With the onset of the polymerization, the temperature rose to 80-90° C. within about 25 min. A solid polymer gel was obtained.

After cooling to about 50° C., the gel block was comminuted with the aid of a meat grinder, and the gel granules obtained were dried in a fluidized bed drier at 55° C. for two hours. Hard white granules were obtained, which were converted to a pulverulent state by means of a centrifugal mill.

Preparation of Polymer C:

A plastic bucket with a magnetic stirrer, pH meter and thermometer was initially charged with 102.3 g of a 35% aqueous solution of sodium acrylate and then the following were added in succession: 115.7 g of distilled water, 0.4 g of a commercial silicone-based defoamer (Dow Corning® Antifoam Emulsion RD), 166.4 g of acrylamide (50% solution in water), 1.2 g of a 5% aqueous solution of diethylenetriaminepentaacetic acid pentasodium salt, and 4 g of a 4% solution (dissolved in 5% sodium hydroxide solution) of the azo initiator 4,4′-azobis(4-cyanovaleric acid).

After adjustment to pH 6.75 by means of 10% sulfuric acid, 1.2 g of macromonomer and 1.2 g of the nonionic surfactant iC₁₃-(EO)₁₅H were added and the pH was checked again and adjusted to pH 6.75. Subsequently, the rest of the water was added to attain the target monomer concentration of 30% (total amount of water minus the amount of water already added, minus the amount of acid required), and the monomer solution was adjusted to the initiation temperature of 4° C. The solution was transferred to a thermos flask, the temperature sensor for the temperature recording was attached, the mixture was purged with nitrogen for 45 minutes and the polymerization was initiated with 4 g of a 4% methanolic solution of the azo initiator azobis(isobutyronitrile), 0.16 mL of a 1% t-BHPO solution and 0.16 mL of a 1% sodium bisulfite solution. With the onset of the polymerization, the temperature rose to 80-90° C. within about 25-30 min. On attainment of the temperature maximum, the polymer was stored at 80° C. for 2 hours. After cooling to about 50° C., the gel block was comminuted with the aid of a meat grinder, and the gel granules obtained were dried in a fluidized bed drier at 55° C. for two hours. Hard white granules were obtained, which were converted to a pulverulent state by means of a centrifugal mill.

Preparation of Polymer D:

A plastic bucket with a magnetic stirrer, pH meter and thermometer was initially charged with 102.3 g of a 35% aqueous solution of sodium acrylate and then the following were added in succession: 115.7 g of distilled water, 0.4 g of a commercial silicone-based defoamer (Dow Corning® Antifoam Emulsion RD), 167.6 g of acrylamide (50% solution in water), 1.2 g of a 5% aqueous solution of diethylenetriaminepentaacetic acid pentasodium salt, and 4 g of a 4% solution (dissolved in 5% sodium hydroxide solution) of the azo initiator 4,4′-azobis(4-cyanovaleric acid).

After adjustment to pH 6.75 by means of 10% sulfuric acid, 0.6 g of macromonomer and 0.6 g of the nonionic surfactant iC₁₃-(EO)₁₅H were added and the pH was checked again and adjusted to pH 6.75. Subsequently, the rest of the water was added to attain the target monomer concentration of 30% (total amount of water minus the amount of water already added, minus the amount of acid required), and the monomer solution was adjusted to the initiation temperature of 4° C. The solution was transferred to a thermos flask, the temperature sensor for the temperature recording was attached, the mixture was purged with nitrogen for 45 minutes and the polymerization was initiated with 4 g of a 4% methanolic solution of the azo initiator azobis(isobutyronitrile), 0.16 mL of a 1% t-BHPO solution and 0.16 mL of a 1% sodium bisulfite solution. With the onset of the polymerization, the temperature rose to 80-90° C. within about 25-30 min. On attainment of the temperature maximum, the polymer was stored at 80° C. for 2 hours. After cooling to about 50° C., the gel block was comminuted with the aid of a meat grinder, and the gel granules obtained were dried in a fluidized bed drier at 55° C. for two hours. Hard white granules were obtained, which were converted to a pulverulent state by means of a centrifugal mill.

Performance Tests:

Determination of Intrinsic Viscosity

To determine the intrinsic viscosity, the flow times of the solvent and the polymer solutions at various concentrations were determined by means of an Ubbelohde capillary viscometer. The ratio of the flow times of the polymer solution and the pure solvent was used to calculate the relative viscosities. Thereafter, the specific viscosities were formed from the difference between the relative viscosity and 1. Finally, the reduced viscosity was formed from the quotient of the specific viscosity and the polymer concentration. This was plotted against the polymer concentration and the intrinsic viscosity was obtained from extrapolation to c=0. The results are reported in table 1 above.

Brookfield Viscosity

The viscosity of polymers C and D was measured as a function of temperature with a Brookfield LV viscometer with a UL adapter (1000 ppm in 1% NaCl solution at 7 s⁻¹).

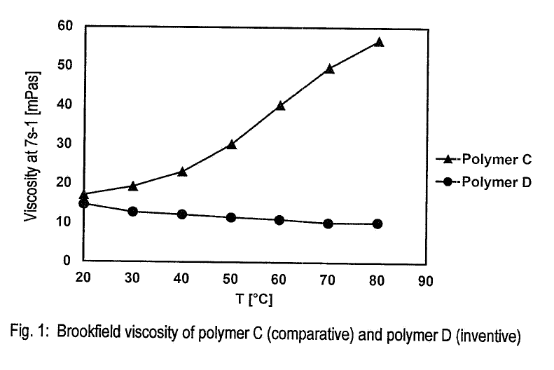

The results are shown in FIG. 1.

Core Flooding Tests—Oil Yield

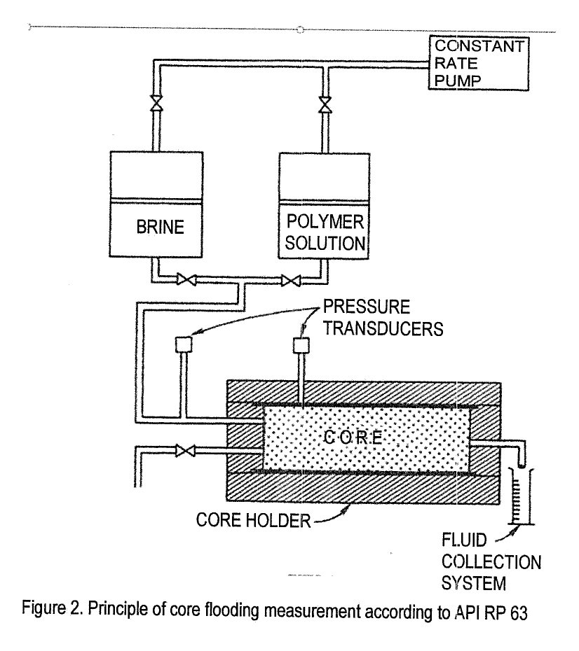

The core flooding tests were conducted with a test setup according to API RP 63, chapter 3.7 (see FIG. 2). The apparatus was equipped with pressure sensors at regular intervals along the core, such that pressure differentials were measured over the entire core and also over subsections of the core.

In each case about one pore volume of an aqueous polymer solution of concentration about 1000 ppm was injected into a Bentheim sandstone core (length of the core: 30.3 cm, diameter: 5.06 cm, pore volume: 139.17 mL, porosity: 22.8%, water permeability: 2890 mD) at a flow rate of 0.3048 m/day. The core had previously been saturated with crude oil. During the injection of the polymer solutions, the pressure differential was measured in individual sections of the sandstone, in order to observe the propagation of the polymer solution through the core.

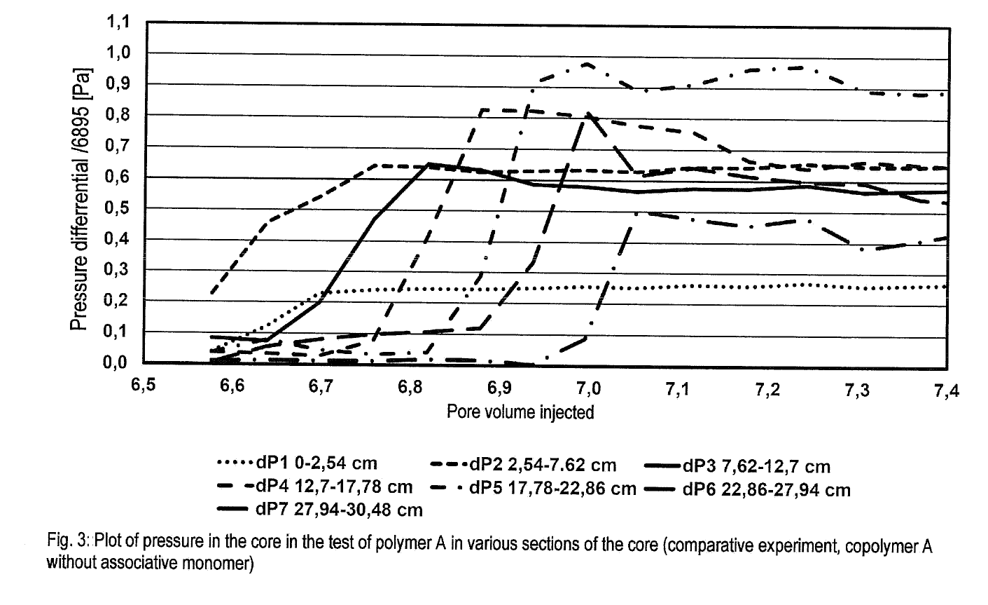

The results of the experiments are compiled in FIGS. 3 to 6 and in table 2.

FIG. 3 shows, for comparative purposes, the results with polymer A, i.e. a polymer without associative monomer. The pressure differential in the individual segments of the core is comparably high in each case. This result means that the polymer A flows homogeneously through the core.

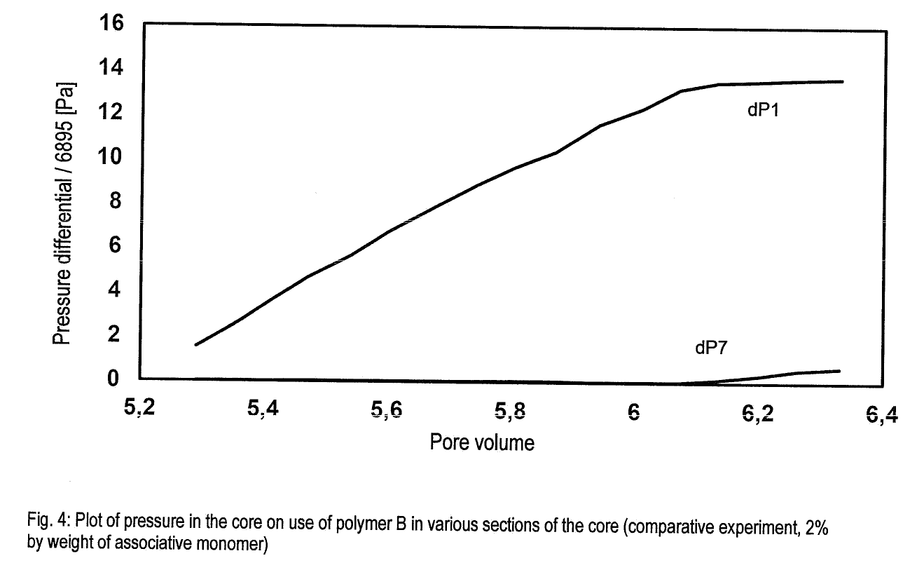

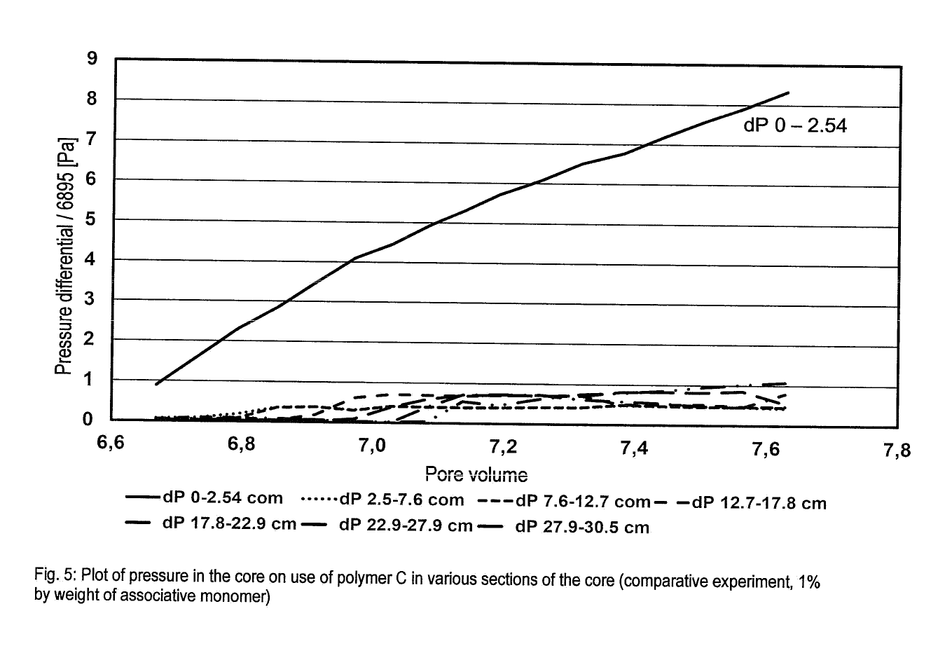

FIGS. 4 and 5 show the results of the comparative experiments with polymers B (2% by weight of associative monomer) and C (1% by weight of associative monomer). In these comparative experiments, the pressure rise in the first core segment (dP1) is significantly higher than in the subsequent segments. Another observation in some cases is no stabilization at all of the pressure level. This means that a majority of the polymer is retained in the foremost portion of the core.

This in turn has adverse effects on oil production.

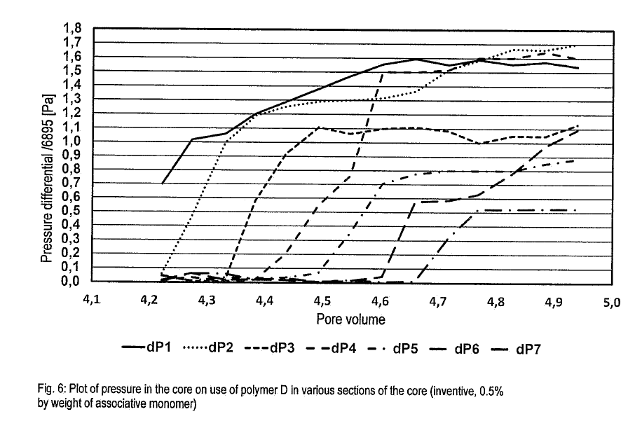

FIG. 6 shows the results of the inventive experiments with polymer D (only 0.5% by weight of associative monomer). This polymer has homogeneous propagation through the core, similarly to polymer A.

The results of the core flooding tests are summarized in table 2. The terms used here have the following meanings:

TABLE 2
Summary of the results of the core flooding tests

| | |
|---|---|
| Oil yield after polymer flooding | Volume of oil produced during the |
| [mL] | polymer injection |
| Residual oil saturation Sₒᵣ | Oil saturation after water injection, |
| | but before polymer injection |
| Initial oil saturation Sₒᵢ | Oil saturation at the start of the |
| | experiment, i.e. prior to the injection |
| | of the water |
| Peak polymer oil cut | Maximum proportion of oil in the |
| [% by vol.] | total amount of fluid produced |
| | (oil + water) |
| Total oil yield | Oil saturation at the end of the |
| | experiment after injections of all |
| | fluids |

| Example No. | C1 | C2 | C3 | 1 |
|---|---|---|---|---|
| Polymer | A | B | C | D |
| Amount of associative monomer | 0% | 2% | 1% | 0.5% |
| Oil yield after polymer flooding [mL] | 10.60 | 6.2 | 9.86 | 13.34 |
| Oil yield after polymer flooding, based on | 17.7 | 9.8 | 16.1 | 22.4 |
| residual oil saturation Sₒᵣ [%] | | | | |
| Oil yield after polymer flooding, based on | 8.2 | 5.2 | 7.7 | 10.8 |
| initial oil saturation Sₒᵢ [%] | | | | |
| Peak polymer oil cut [% by vol.] | 31.1 | 2.2 | 12.1 | 41.4 |
| Total oil yield, based on Sₒᵢ [%] | 61.9 | 51.6 | 59.9 | 62.5 |

An essential factor for the efficacy of the polymer flooding is firstly the total oil yield, which can be determined by means of the core flooding test. Another important factor is also the question of how quickly the oil can be produced. An indicator of this is the peak polymer oil cut. On injection of the polymer solution into the core, a mixture of (polymer-comprising) water and oil is typically produced. The peak polymer oil cut is the highest concentration of oil, based on water and oil, which is produced in the course of the experiment. A high value means that the greatest amount of oil is produced relatively quickly in a high concentration. A low value means that the oil production is spread over a wide range.

As can be seen in table 2, the best oil yield is achieved in experiment 1 (polymer D). In addition, the peak polymer oil cut is at its greatest at 41.4% by volume.

Core Flooding Tests—Temperature Dependence

For the experiments, a solution of 1000 ppm of polymer D in synthetic seawater was used. The synthetic seawater had the following composition:

| Salt | Concentration [g/L] |
|---|---|
| Na₂SO₄ | 3.408 |
| NaHCO₃ | 0.168 |
| KCl | 0.746 |
| NaCl | 23.5 |
| MgCl₂ × 6 H₂O | 9.149 |
| CaCl₂ × 2 H₂O | 1.911 |

The concentration of the divalent ions (Mg²⁺ and Ca²⁺) is 1.6 g/L. The solution was injected into Bentheim sandstone at various flow rates and temperatures, in the sequence specified in table 3 (step 1 to step 8). The pressure differential across the core was measured in each case. For comparative purposes, synthetic seawater without polymer was injected into the core under the same conditions and the pressure differential was likewise measured in each case. The quotient of the pressure differentials was used to calculate the resistance factor (RF) (RF=pressure differential of polymer in seawater/pressure differential with pure seawater). The RF is a measure of the apparent viscosity of the solution in the porous medium.

The results of the experiments are compiled in table 3.

TABLE 3
Determination of the resistance factor (RF)

| Steps | Flow rate [mL/min] | T [° C.] | Resistance factor |
|---|---|---|---|
| 1 | 0.5 | 20 | 14.9 |
| 2 | 0.5 | 45 | 93.8 |
| 3 | 0.5 | 60 | 152 |
| 4 | 0.2 | 60 | 323 |
| 5 | 0.1 | 60 | 562 |
| 6 | 0.1 | 20 | 15.9 |
| 7 | 0.2 | 20 | 17.0 |
| 8 | 0.5 | 20 | 21.4 |

FIG. 1 shows the Brookfield viscosity of polymers C (comparative) and D (inventive). The viscosity of C rises with increasing temperature, whereas that of polymer D decreases slightly with increasing temperature. A rise in viscosity with temperature is indeed desirable: typically, the polymer solution is at about room temperature prior to injection. After injection into the deposit, the solution heats up under the influence of the deposit, with increasing viscosity. In this respect, the person skilled in the art would consider polymer D to be of low suitability.

Surprisingly, the core flooding test with polymer D also shows that polymer D leads to better deoiling with rising temperature. As can be seen in table 2, there is a distinct rise in the RF with temperature (step 1→3). A high RF means a distinct reduction in the mobility of the aqueous polymer solution compared to the solution without polymer. Lower mobility leads to more homogeneous propagation of the solution through the formation, such that oil is mobilized even in regions having relatively low permeability. This behavior is remarkable because the viscosity of the polymer in synthetic seawater decreases with rising temperature. The person skilled in the art would therefore expect worsened deoiling on the basis of the viscosity measurements. The behavior is reversible. At the end of the test sequence (step 8), measurement was again effected at 0.5 mL/min and 20° C., and the RF is about the same.

1.-19. (canceled)

20. A method of producing mineral oil from underground mineral oil deposits comprising mineral oil and saline deposit water, in which an aqueous formulation comprising injecting at least one thickening water-soluble copolymer (P) into the mineral oil deposit through at least one injection well and withdrawing mineral oil from the deposit through at least one production well, wherein the water-soluble copolymer (P) comprises at least
65% to 85% by weight of at least one monomer (A) selected from the group consisting of (meth)acrylamide, N-methyl(meth)acrylamide, N,N-dimethyl(melh)acrylamide and N-methylol(meth)acrylamide, and
14.9% to 34.9% by weight of at least one monomer (B) selected from the group consisting of acrylic acid, methacrylic acid, crotonic acid, itaconic acid, maleic acid, fumaric acid and salts thereof,
wherein
the water-soluble copolymer (P) further comprises 0.1% to 0.9% by weight of at least one monoethylenically unsaturated monomer (C) selected from the group consisting of
H₂C═C(R¹)—O—(—CH₂—CH(R⁵)—O—)ₖ—R⁶ (I),
H₂C═C(R¹)—(C═O)—O—(—CH₂—CH(R⁵)—O—)ₖ—R⁶ (II),
H₂C═C(R¹)—R⁷—O—(—CH₂—CH(R⁸)—O—)ₓ—(—CH₂—CH(R⁹)—O—)_{y}—(—CH₂—CH₂O—)_{z}—R¹⁰ (III),
H₂C═C(R¹)—C(═O)O—R¹¹—N⁺(R¹²)(R¹³)(R¹⁴)X⁻ (IV) or
H2C═C(R1)-C(═O)N(R15)-R11-N+(R12)(R13)(R14)X− (V),
where the radicals and indices are defined as follows:
R¹: H or methyl;
R⁵: independently H, methyl or ethyl, with the proviso that at least 70 mol % of the R⁵ radicals are H,
R⁶: aliphatic and/or aromatic, linear or branched hydrocarbyl radicals having 8 to 40 carbon atoms,
R⁷: a single bond or a divalent linking group selected from the group consisting of —(CₙH₂ₙ)—, —O—(C_{n′}H_{2n′})— and —C(O)—O—(C_{n″}H_{2n′}′)—, where n is a natural number from 1 to 6, and n′ and n″ are a natural number from 2 to 6,
R⁸: independently H, methyl or ethyl, with the proviso that at least 70 mol % of the R⁸ radicals are H,
R⁹: independently hydrocarbyl radicals of at least 2 carbon atoms,
R¹⁰: H or a hydrocarbyl radical having 1 to 30 carbon atoms,
R¹¹: an alkylene radical having 1 to 8 carbon atoms,
R¹², R¹³, R¹⁴: independently H or an alkyl group having 1 to 4 carbon atoms,
R¹⁵: aliphatic and/or aromatic, linear or branched hydrocarbyl radicals having 8 to 30 carbon atoms,
X⁻ a negatively charged counterion,
k a number from 10 to 80,
a number from 10 to 50,
a number from 5 to 30, and
z a number from 0 to 10,
the deposit temperature is ≤70° C.,
the permeability of the deposit is ≥100 mD, and
the deposit water comprises not more than 10 g/L of divalent ions.

21. The method according to claim 20, wherein the amount of the monomer (C) is 0.2% to 0.8% by weight.

22. The method according to claim 20, wherein the amount of the monomer (C) is 0.4% to 0.6% by weight.

23. The method according to claim 20, wherein the monomer (C) is at least one monomer of the general formula (III).

24. The method according to claim 23, wherein the monomers (C) are a mixture comprising at least the following monomers:
H₂C═C(R¹)—R⁷—O—(—CH₂—CH(R⁸)—O—)ₓ—(—CH₂—CH(R⁹)—O—)_{y}—H (IIIa) and
H₂C═C(R¹)—R⁷—O—(—CH₂—CH(R⁸)—O—)ₓ—(—CH₂—CH(R⁹)—O—)_{y}—(—CH₂—CH₂O—)_{z}—H (IIIb),
where the radicals and indices have the definition outlined above, with the proviso that, in the formula (IIIb), z is a number >0 to 10.

25. The method according to claim 24, wherein, in the formulae (IIIa) and (IIIb), R¹ is H, R⁷ is a —O—(C_{n′}H_{2n′})— group, R⁸ is H, R⁹ is ethyl, x is 20 to 30, y is 12 to 25, and z is 1 to 6.

26. The method according to claim 24, wherein, in the formulae (IIIa) and (IIIb), R¹ is H, R⁷ is —O—CH₂CH₂CH₂CH₂—, R⁸ is H, R⁹ is ethyl, x is 23 to 26, y is 14 to 18, and z is 3 to 5.

27. The method according to claim 20, wherein the deposit temperature is 30° C. to 70° C.

28. The method according to claim 20, wherein the permeability of the deposit is 200 mD to 2 D.

29. The method according to claim 20, wherein the deposit water comprises 0.1 to 10 g/L of divalent ions.

30. The method according to claim 20, wherein the amount of monomers (A), (B) and (C) together is 100% by weight.

31. A water-soluble copolymer (P) comprising at least
65% to 85% by weight of at least one monomer (A) selected from the group consisting of (meth)acrylamide, N-methyl(meth)acrylamide, N,N′-dimethyl(meth)acrylamide and N-methylol(meth)acrylamide, and
14.9% to 34.9% by weight of at least one monomer (B) selected from the group consisting of acrylic acid, methacrylic acid, crotonic acid, itaconic acid, maleic acid, fumaric acid and salts thereof,
wherein the water-soluble copolymer (P) further comprises 0.1% to 0.9% by weight of at least one monoethylenically unsaturated monomer (C) selected from the group consisting of
H₂C═C(R¹)—O—(—CH₂—CH(R⁵)—O—)ₖ—R⁶ (I),
H₂C═C(R¹)—(C═O)—O—(—CH₂—CH(R⁵)—O—)ₖ—R⁶ (II),
H₂C═C(R¹)—R⁷—O—(—CH₂—CH(R⁸)—O—)ₓ—(—CH₂—CH(R⁹)—O—)_{y}—(—CH₂—CH₂O—)_{z}—R¹⁰ (III),
H₂C═C(R¹)—C(═O)O—R¹¹—N⁺(R¹²)(R¹³)(R¹⁴)X⁻ (IV) and
H₂C═C(R¹)—C(═O)N(R¹⁵)—R¹¹—N⁺(R¹²)(R¹³)(R¹⁴)X⁻ (V),
where the radicals and indices are defined as follows:
R¹: H or methyl;
R⁵: independently H, methyl or ethyl, with the proviso that at least 70 mol % of the R⁵ radicals are H,
R⁶: aliphatic and/or aromatic, linear or branched hydrocarbyl radicals having 8 to 40 carbon atoms,
R⁷: a single bond or a divalent linking group selected from the group consisting of —(CₙH₂ₙ)—, —O—(C_{n′}H_{2n′})— and —C(O)—O—(C_{n″}H_{2n′}′)—, where n is a natural number from 1 to 6, and n′ and n″ are a natural number from 2 to 6,
R⁸: independently H, methyl or ethyl, with the proviso that at least 70 mol % of the R⁸ radicals are H,
R⁹: independently hydrocarbyl radicals of at least 2 carbon atoms,
R¹⁰: H or a hydrocarbyl radical having 1 to 30 carbon atoms,
R¹¹: an alkylene radical having 1 to 8 carbon atoms,
R¹², R¹³, R¹⁴: independently H or an alkyl group having 1 to 4 carbon atoms,
R¹⁵: aliphatic and/or aromatic, linear or branched hydrocarbyl radicals having 8 to 30 carbon atoms,
X⁻ a negatively charged counterion,
Tc a number from 10 to 80,
a number from 10 to 50,
y a number from 5 to 30, and
z a number from 0 to 10.

32. The water-soluble copolymer (P) according to claim 31, wherein the amount of the monomer (C) is 0.2% to 0.8% by weight.

33. The water-soluble copolymer (P) according to claim 31, wherein the amount of the monomer (C) is 0.4% to 0.6% by weight.

34. The water-soluble copolymer (P) according to claim 31, wherein the monomer (C) is at least one monomer of the general formula (III).

35. The water-soluble copolymer (P) according to claim 34, wherein the monomers (C) are a mixture comprising at least the following monomers:
H₂C═C(R¹)—R⁷—O—(—CH₂—CH(R⁸)—O—)ₓ—(—CH₂—CH(R⁹)—O—)_{y}—H (IIIa) and
H₂C═C(R¹)—R⁷—O—(—CH₂—CH(R⁸)—O—)ₓ—(—CH₂—CH(R⁹)—O—)_{y}—(—CH₂—CH₂O—)_{z}—H (IIIb),
where the radicals and indices have the definition outlined above, with the proviso that, in the formula (IIIb), z is a number >0 to 10.

36. The water-soluble copolymer (P) according to claim 35, wherein, in the formulae (IIIa) and (IIIb), R¹ is H, R⁷ is a —O—(C_{n′}H_{2n′})— group, R⁸ is H, R⁹ is ethyl, x is 20 to 30, y is 12 to 25, and z is 1 to 6.

37. The water-soluble copolymer (P) according to claim 35, wherein, in the formulae (IIIa) and (IIIb), R¹ is H, R⁷ is —O—CH₂CH₂CH₂CH₂−, R⁸ is H, R⁹ is ethyl, x is 23 to 26, y is 14 to 18, and z is 3 to 5.

38. The water-soluble copolymer (P) according to claim 31, wherein the amount of monomers (A), (B) and (C) together is 100% by weight.
